(19) United States
(12) Patent Application Publication
(10) Pub. No.: US 2026/0038880 A1
(43) Pub. Date: Feb. 5, 2026

(54) ELECTROLYTES WITH LOW CATIONIC MOBILITY ACTIVATION ENERGIES

(71) Applicant: Toyota Motor Engineering & Manufacturing North America, Inc., Plano, TX (US)

(72) Inventors: Rana Mohtadi, Northville, MI (US); Hiroko Kuwata, Ann Arbor, MI (US); Oscar Tutusaus, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/358,619

(22) Filed: Oct. 15, 2025

Related U.S. Application Data
(63) Continuation of application No. 17/846,334, filed on Jun. 22, 2022, now Pat. No. 12,469,884.

(51) Int. Cl. H01M 10/0568; H01M 10/052; H01M 10/0562; H01M 10/39

(52) U.S. Cl. CPC H01M 10/0568; H01M 10/052; H01M 10/0562; H01M 10/399; H01M 2300/0048; H01M 2300/0065

(57) ABSTRACT

An electrolyte includes a composite salt mixture with between 0.975 and 0.05 mole fraction of a halogen-free closo-borate salt and between 0.025 and 0.95 mole fraction of a halogenated closo-borate salt, and a first activation energy before a heat treatment and a second activation energy after the heat treatment, the second activation energy being less than the first activation energy.

### CROSS-REFERENCE TO RELATED APPLICATION

This application is a continuation application of currently pending U.S. patent application Ser. No. 17/846,334, filed on Jun. 22, 2022, which is incorporated herein in its entirety by reference.

### TECHNICAL FIELD

The present disclosure generally relates to electrolytes, and particularly to electrolytes for lithium, sodium, magnesium or calcium batteries.

### BACKGROUND

Solid-state electrolytes provide many advantages in secondary battery design, including mechanical stability, no volatility, and ease of construction. Typical inorganic solid-state electrolytes having high ionic conductivity are sulfides-based electrolytes. For example, Zhang et al. reported that the ionic conductivity for a sulfide electrolyte can exceed 25 mS/cm, which is advantageous for battery applications (Zhang Z et al. Energy Environ. Sci., 2018, 11, 1945). However, sulfide-based electrolytes suffer from the high propensity to form H₂S toxic gases upon exposure to low level of moisture, which challenges their practical use. Other classes such as polymeric and other organic have inferior ionic mobility at technologically relevant temperatures below 60° C.

The present disclosure addresses these issues with solid-state electrolytes, and other issues related to electrolytes.

### SUMMARY

In one form of the present disclosure, an electrolyte includes a composite salt mixture with between 0.975 and 0.05 mole fraction of a halogen-free closo-borate salt and between 0.025 and 0.95 mole fraction of a halogenated closo-borate salt, and a first activation energy before a heat treatment and a second activation energy after the heat treatment, the second activation energy being less than the first activation energy.

In another form of the present disclosure, an electrolyte includes a composite salt mixture with between 0.975 and 0.05 mole fraction of a halogen-free closo-borate salt, between 0.025 and 0.95 mole fraction of a halogenated closo-borate salt, and an activation energy less than 0.65 EV for temperatures above 30° C.

In still another form of the present disclosure, a method includes mixing a halogen-free closo-borate salt and a halogenated closo-borate salt and forming a solid state electrolyte with between 0.975 and 0.05 mole fraction of the halogen-free closo-borate salt, between 0.025 and 0.95 mole fraction of the halogenated closo-borate salt, and an activation energy less than 0.65 EV for temperatures equal to and above 30° C.

These and other features of the nearly solvent-free combined salt electrolyte and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is an Arrhenius plot of cationic conductivity versus temperature for a halogen-free closo-borate salt, and a composite salt mixture of the halogen-free closo-borate salt and the halogenated closo-borate salt according to the teachings of the present disclosure;

FIG. 2 is an Arrhenius plot of cationic conductivity versus temperature for a halogen-free closo-borate salt, and another composite salt mixture of the halogen-free closo-borate salt and the halogenated closo-borate salt according to the teachings of the present disclosure; and

FIG. 3 is a plot of cationic conductivity and activation energy versus % molar content of the halogenated closo-borate salt LiCB₁₁H₁₁F in a LiCB₁₁H₁₂—LiCB₁₁H₁₁F composite salt mixture.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

In an effort to overcome the issues related to sulfide-based electrolytes noted above, polymeric electrolytes and other organic electrolytes have been studied but found to exhibit inferior ionic mobility at technologically relevant temperatures below 60° C. And recently, closo-borates salts have been reported to possibly form superionic conductors at above 50° C., and for many of these salts at above 120° C. In some instances, these super conductor high temperature phases can be stabilized at room temperature for limited closo-borate salts (e.g., see U.S. Pat. No. 10,553,897; Kim S. et al. Nature Communications 10:1081, 2019; Tang W. S. et al. ACS Energy Lett. 2016, 1, 659-664). However, such an approach is problematic as the ionic conduction property, which includes the activation energy, is dictated by the intrinsic property and structural features of the high temperature phases. In fact, salts of closo borates, and also most polymeric and other solid-state inorganic electrolytes, generally exhibit relatively high activation energies for cationic mobility at temperatures below 60° C., which in turn implies a strong effect of the temperature on cationic mobility—a property not desired for device operation. For example, the lowest activation energy for a room temperature superionic closo-borate lithium cation conductor has been reported to be greater than 0.29 eV (Kim S. et al., Nature Communications 10:1081, 2019). And the activation energy for Li closo carborane salts exceeded 0.31 eV for temperatures above 39° C. and increased to 0.74 eV as these electrolytes were cooled below 39° C. (Tang W. S. et al. ACS Energy Lett. 2016, 1, 659-664).

In contrast to previous teachings, the present disclosure provides electrolytes with low activation energies (i.e., less than 0.28 eV) that include a composite salt mixture in which at least two different salts are in direct contact with each other. The composite salt mixture includes a combination of a halogen-free closo-borate salt and a halogenated closo-borate salt (also referred to herein simply as “combined halogen-free closo-borate/halogenated closo-borate salt”) and the combined halogen-free closo-borate/halogenated closo-borate salt provides an electrolyte with a cationic conductivity that is at least one order of magnitude greater than a cationic conductivity of the halogen-free closo-borate salt, at least one order of magnitude greater than a cationic conductivity of the halogenated closo-borate salt, and low activation energies at room temperature (i.e., 20-22° C.). In addition, electrolytes according to the teachings of the present disclosure can exhibit and/or maintain relatively low activation energies even after cooling to sub-ambient temperatures.

In some variations of the present disclosure, the halogen-free closo-borate salt includes a cation selected from Li⁺, Na⁺, Mg²⁺, and Ca²⁺, and a closo-borate anion with the structure [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, and where y is an integer within a range of 6 to 12, (z) is an integer within a range of 0 to y, (t) is an integer within a range of 0 to (y-1), and R is a linear, branched-chain, or cyclic C1-C18 alkyl or fluoroalkyl group. And in at least one variation, the halogenated closo-borate salt includes a cation selected from Li⁺, Na⁺, Mg²⁺, and Ca²⁺, and a closo-borate anion with the structure [B_{y}H_{(y-z-f)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12, (z+i) is an integer within a range of 0 to y, (t+j) is an integer within a range of 0 to (y-1), X is F, Cl, Br, I, or a combination thereof, and R is a linear, branched-chain, or cyclic C1-C18 alkyl or fluoroalkyl group. In the alternative, X is a halogenated alkyl group containing CF₃. For example, in some variations the closo-borate anion of the halogen-free closo-borate salt and/or the halogenated closo-borate salt is B₁₂H₁₂⁻², B₁₀H₁₀⁻², CB₁₁H₁₂⁻¹ or CB₉H₁₀⁻¹, or a substituted derivative thereof. It should be understood that the large sizes of the closo-borates anions, such as B₁₂H₁₂⁻², B₁₀H₁₀⁻², CB₁₁H₁₂⁻¹, and CB₉H₁₀⁻¹, are attractive for solid-state batteries since such anions display orientation mobility and a dynamic frustration that allows order-disorder phase transitions, which in turn leads to high cation mobility for enhanced ion conduction.

A cation of the of the halogen-free closo-borate salt can be the same or different than a cation of the halogenated closo-borate salt. Accordingly, an electrolyte formulation with the composite salt mixture can include multiple different closo-borate anions and multiple different cations. The mole percentage (mol %) of the Li⁺, Ca⁺, Mg²⁺, and/or Ca²⁺ cation(s) s of the total cations in the electrolyte can be from about 1 to about 100 percent and the mole percentage of closo-borate anions of all anions of the electrolyte can be from about 0.5 to about 100 percent.

In some variations, an electrolyte with the composite salt mixture can include one or more additional cation conductivity enhancing anions. A mole fraction of the one or more additional conductivity enhancing anion to the total anions in the composite salt mixture can be from about 0.01 to about 0.9. Also, the one or more additional conductivity enhancing anions can be selected from F⁻, Cl⁻, Br, I, RₓBF₄₋ₓ⁻, R_{y}PF_{6-y}⁻, SbF₆⁻, ClO₄⁻, SO₄⁻², N(SO₂F)₂^{<}, N(SO₂(CF₂)ₙCF₃)₂⁻, [NSO₂(CF₂)ₙ₊₁SO₂], or CF₃(CF₂)ₙSO₃⁻, where: n is 0 to 5; x is 0 to 4; y is 0 to 6; and R is a linear, branched, or cyclic alkyl group that can be unsubstituted, partially fluorinated, or fully fluorinated.

In at least one variation, an electrolyte is formulated from the combined halogen-free closo-borate/halogenated closo-borate salt with an addition of an organic plastic crystal such that a soft solid electrolyte with appreciable cation conductivity(ies) is provided. The organic plastic crystal material can be a succinonitrile-glutaronitrile mixture where the mole percent of glutaronitrile is 15 to 96 mole % and the plastic state (i.e., the organic plastic crystal) promotes cation conductivities of more than 10-7 S/cm at 60° C. And in some variations, the electrolyte includes the combined halogen-free closo-borate/halogenated closo-borate salt, the organic plastic crystal, and the one or more additional cation conductivity enhancing anions.

In one form of the present disclosure, the combined halogen-free closo-borate/halogenated closo-borate salt is included in a solid-state electrolyte for a solid-state electrochemical device. In another form of the present disclosure, an electrolyte with the combined halogen-free closo-borate/halogenated closo-borate salt is in a partially liquid molten state at room temperature (i.e., 20-25° C.). And in still another form, an electrolyte with the combined halogen-free closo-borate/halogenated closo-borate salt in a fully liquid molten state at room temperature.

In some variations, a combined halogen-free closo-borate/halogenated closo-borate salt is prepared by combining or mixing appropriate amounts of a halogen-free closo-borate salt and a halogenated closo-borate salt using mechanochemical synthetic ball milling followed by an optional heat treatment of the ball milled material at temperatures less than 200° C. and an optional ball milling homogenization step. In other variations, a combined halogen-free closo-borate/halogenated closo-borate salt is prepared using solution-based synthesis in which appropriate amounts of a halogen-free closo-borate salt and a halogenated closo-borate salt are dissolved in a solvent (e.g., an ether solvent) followed by a solvent removal step and an optional ball milling homogenization step.

In some variations, an electrochemical device that includes an anode, a cathode, and an electrolyte with the combined halogen-free closo-borate/halogenated closo-borate salt in contact with the anode and the cathode is provided in the present disclosure. The electrochemical device can be a secondary battery or a subunit of a secondary battery. The anode is an electrode where alkali metal or alkali earth metal oxidation occurs during the device's discharge and where reduction occurs during the device's charge. Similarly, the cathode is an electrode where a cathode material reduction occurs during the device's discharge and a cathode material oxidation occurs during the device's charge.

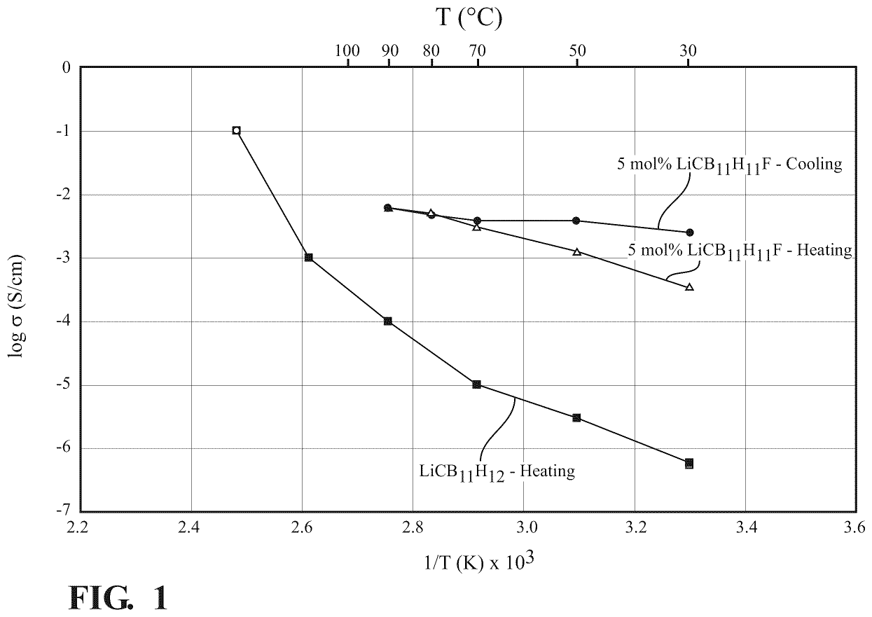

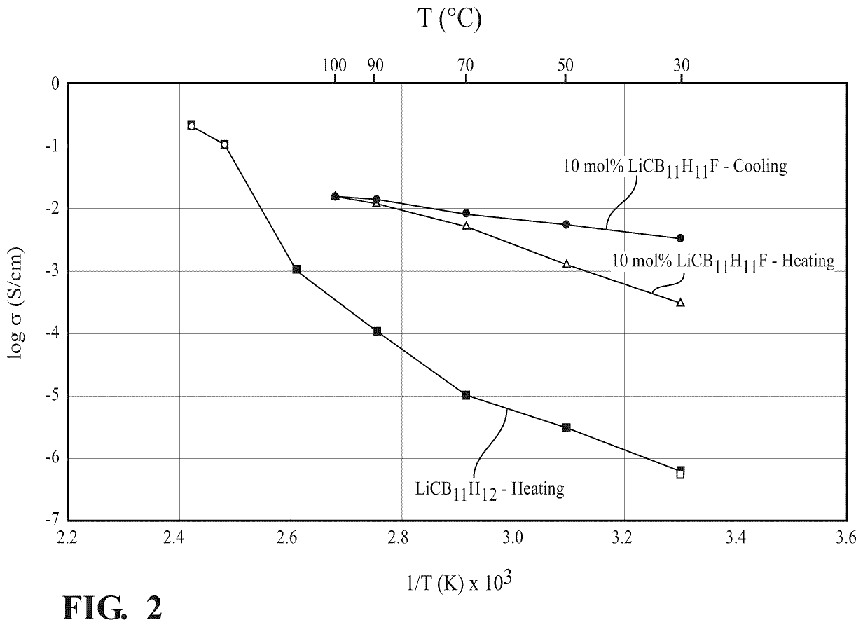

Referring now to FIGS. 1 and 2, Arrhenius plots of conductivity versus temperature for two combined halogen-free closo-borate/halogenated closo-borate salts according to the teachings of the present disclosure are shown. Particularly, FIG. 1 shows an Arrhenius plot for a combined 95 mol % LiCB₁₁H₁₂/5 mol % LiCB₁₁H₁₁F salt subjected to cationic conductivity measurements at 30, 50, 70, 80, and 90° C. during heating of the combined 95 mol % LiCB₁₁H₁₂/5 mol % LiCB₁₁H₁₁F salt (labeled “5 mol % LiCB₁₁H₁₁F-Heating”) and cationic conductivity measurements at 90, 80, 70, 50, and 30° C. following the heating of the combined 95 mol % LiCB₁₁H₁₂/5 mol % LiCB₁₁H₁₁F salt (labeled “5 mol % LiCB₁₁H₁₁F-Cooling”). FIG. 2 shows an Arrhenius plot for a combined 90 mol % LiCB₁₁H₁₂/10 mol % LiCB₁₁H₁₁F salt subjected to cationic conductivity measurements at 30, 50, 70, 90, and 100° C. during heating (labeled “10 mol % LiCB₁₁H₁₁F-Heating”) and cationic conductivity measurements at 100, 90, 70, 50, and 30° C. following the heating of the combined 90 mol % LiCB₁₁H₁₂/10 mol % LiCB₁₁H₁₁F salt (labeled “10 mol % LiCB₁₁H₁₁F-Cooling”). And for comparison, FIGS. 1 and 2 also show cationic conductivities for neat LiCB₁₁H₁₂ during heating.

The combined 95 mol % LiCB₁₁H₁₂/5 mol % LiCB₁₁H₁₁F salt and the combined 90 mol % LiCB₁₁H₁₂/10 mol % LiCB₁₁H₁₁F salt were prepared by mixing LiCB₁₁H₁₂ and LiCB₁₁H₁₁F salts with a mortar and pestle, followed by ball milling at 700 revolutions per minute (RPM) for 24 hours to ensure uniformity of the combined LiCB₁₁H₁₂/LiCB₁₁H₁₁F salts. A solid-state electrolyte pellet for each of the combined LiCB₁₁H₁₂/LiCB₁₁H₁₁F salts was formed by pressing a given LiCB₁₁H₁₂/LiCB₁₁H₁₁F salt mixture under at least 120 MPa of pressure. Also, carbon coated aluminum foil was used as the working electrode and the counter electrode of a two-electrode cell, and a solid-state electrolyte pellet of the combined 95 mol % LiCB₁₁H₁₂/5 mol % LiCB₁₁H₁₁F salt or the combined 90 mol % LiCB₁₁H₁₂/10 mol % LiCB₁₁H₁₁F salt was in direct contact with the working and counter electrodes during cationic conductivity measurements.

Referring particularly to FIG. 1, the combined 95 mol % LiCB₁₁H₁₂/5 mol % LiCB₁₁H₁₁F salt exhibited cationic conductivities of about 9.3×10⁻⁴ S/cm at 30° C. initially. In contrast, the neat LiCB₁₁H₁₂ salt exhibited cationic conductivities initially of about 1.5×10⁻⁶ S/cm at 30° C. In addition, an increase in cationic conductivity of the combined 95 mol % LiCB₁₁H₁₂/5 mol % LiCB₁₁H₁₁F salt after heat treatment and an extremely low activation energy of 0.209 eV can be obtained. Accordingly, the cationic conductivity of the combined 95 mol % LiCB₁₁H₁₂/5 mol % LiCB₁₁H₁₁F salt at 30° C. was greater than 1000 times the cationic conductivity of the LiCB₁₁H₁₂.

Referring particularly to FIG. 2, the combined 90 mol % LiCB₁₁H₁₂/10 mol % LiCB₁₁H₁₁F salt exhibited cationic conductivities initially of about 7.2×10⁻⁴ S/cm at 30° C. and about 7.9×10⁻³ S/cm at 30° C. following the heating cycle. In contrast, the neat LiCB₁₁H₁₂ salt exhibited cationic conductivities of about 1.5×10⁻⁶ S/cm at 30° C. Accordingly, the cationic conductivity of the combined 90 mol % LiCB₁₁H₁₂/10 mol % LiCB₁₁H₁₁F at 30° C. salt was greater than 100 times the cationic conductivity of the LiCB₁₁H₁₂. In addition, the cationic conductivity of the combined 90 mol % LiCB₁₁H₁₂/10 mol % LiCB₁₁H₁₁F salt can be further increased to 7.9×10⁻³ S/cm at 30° C. after heat treatment and an extremely low activation energy of 0.209 eV can be obtained.

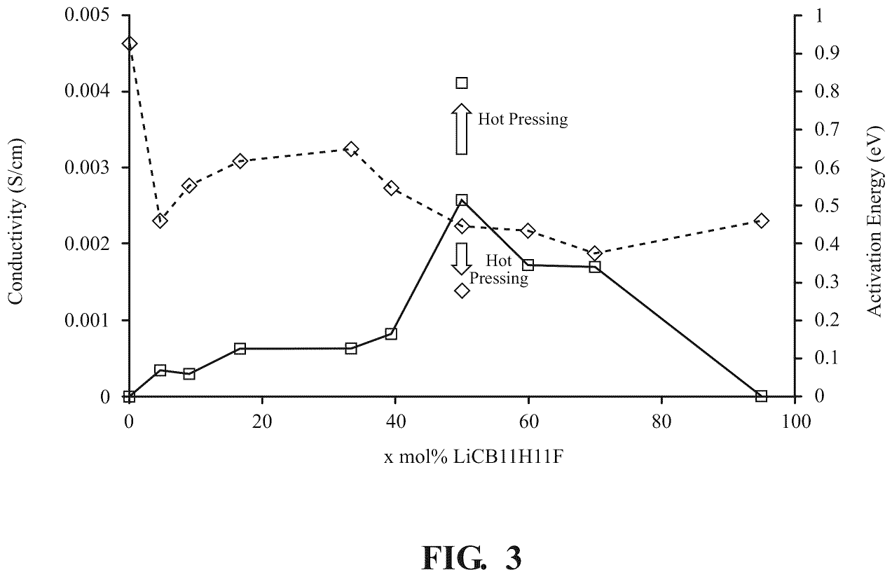

Referring now to FIG. 3, a plot of conductivity and activation energy at 30° C. for a plurality LiCB₁₁H₁₂—LiCB₁₁H₁₁F compositions is shown. The compositions were cold pressed and not subjected to thermal activation, except for the two data points shown for a LiCB₁₁H₁₂-50 mol % LiCB₁₁H₁₁F composition. And as observed from FIG. 3, the conductivity of 100 mol % LiCB₁₁H₁₂ and LiCB₁₁H₁₂-95 mol % LiCB₁₁H₁₁F (solid line) is very low compared to desired compositions of LiCB₁₁H₁₂ and LiCB₁₁H₁₂ For example, compositions such as LiCB₁₁H₁₂-50 mol % LiCB₁₁H₁₁F can be greater than 1000 times that of 100 mol % LiCB₁₁H₁₂ and greater than 1000 times that of 100 mol % LiCB₁₁H₁₁F. In addition, the plot of conductivity versus composition illustrated a specific range or “sweet spot” of compositions that provide enhanced conductivity at 30° C. In some variations the range of compositions that provide enhanced conductivity is between about LiCB₁₁H₁₂-40 mol % LiCB₁₁H₁₁F and about LiCB₁₁H₁₂-80 mol % LiCB₁₁H₁₁F, while in other variations the range is between about LiCB₁₁H₁₂-45 mol % LiCB₁₁H₁₁F and about LiCB₁₁H₁₂-75 mol % LiCB₁₁H₁₁F. And in at least one variation the range of compositions that provide enhanced conductivity is between about LiCB₁₁H₁₂-45 mol % LiCB₁₁H₁₁F and about LiCB₁₁H₁₂-70 mol % LiCB₁₁H₁₁F. In addition, the LiCB₁₁H₁₂-50 mol % LiCB₁₁H₁₁F composition was further hot pressed and this hot pressed composition exhibited an even higher conductivity (almost two time greater) compared to the LiCB₁₁H₁₂-50 mol % LiCB₁₁H₁₁F composition without hot pressing.

Still referring to FIG. 3, and regarding the activation energy for the plurality LiCB₁₁H₁₂—LiCB₁₁H₁₁F compositions (dashed line), all of the tested LiCB₁₁H₁₂—LiCB₁₁H₁₁F compositions that included LiCB₁₁H₁₁F exhibited an activation energy less than 0.65 eV at 30° C. In some variations (i.e., for some compositions), the activation energy was less than 0.61 EV, while in other variations the activation energy was less 0.58 eV. In at least one variation the activation energy was less than 0.51 eV, and in some variations the activation energy was less than 0.47 eV, for example, less than 0.42 eV and less than 0.40 eV. And for the LiCB₁₁H₁₂-50 mol % LiCB₁₁H₁₁F composition that was further hot pressed, this sample exhibited an activation energy less than 0.33 eV.

Accordingly, it should be understood that a simple or random combination of a halogen-free closo-borate salt and a halogenated closo-borate salt does not inherently provide the combined halogen-free closo-borate/halogenated closo-borate salts according to the teachings of the present disclosure. Stated differently, a specific range of compositions according to the teachings of the present disclosure provide a composite salt with enhanced conductivity and low activation energy.

It should be understood from FIGS. 1, 2, and 3 that the combined halogen-free closo-borate/halogenated closo-borate salts according to the teachings of the present disclosure have or exhibit a cationic conductivity that is at least one order of magnitude greater than a cationic conductivity of the halogen-free closo-borate salt and/or at least one order of magnitude greater than a cationic conductivity of the halogenated closo-borate salt. In some variations, the combined halogen-free closo-borate/halogenated closo-borate salts according to the teachings of the present disclosure have or exhibit a cationic conductivity that is at least two orders of magnitude greater than the cationic conductivity of the halogen-free closo-borate salt and/or at least two orders of magnitude greater than the cationic conductivity of the halogenated closo-borate salt. And in at least one variation, the combined halogen-free closo-borate/halogenated closo-borate salts according to the teachings of the present disclosure have or exhibit a cationic conductivity that is between two and three orders of magnitude greater than the cationic conductivity of the halogen-free closo-borate salt and/or between two and three orders of magnitude greater than the cationic conductivity of the halogenated closo-borate salt, and an activation energy less than 0.28 eV.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrolyte comprising:
a composite salt mixture comprising between 0.975 and 0.05 mole fraction of a halogen-free closo-borate salt and between 0.025 and 0.95 mole fraction of a halogenated closo-borate salt; and
a first activation energy before a heat treatment and a second activation energy after the heat treatment, the second activation energy being less than the first activation energy.

2. The electrolyte according to claim 1, wherein the second activation energy is less than 0.40 eV at temperatures equal to and greater than 30° C.

3. The electrolyte according to claim 1, wherein the second activation energy is less than 0.28 eV at temperatures between and equal to 30° C. and 90° C.

4. The electrolyte according to claim 1, wherein the composite salt mixture comprises a cationic conductivity that is at least one order of magnitude greater than a cationic conductivity of the halogen-free closo-borate salt and a cationic conductivity of the halogenated closo-borate salt at temperatures below 125° C.

5. The electrolyte according to claim 1, wherein the halogen-free closo-borate salt comprises a first cation selected from the group consisting of Lit, Na⁺, Mg²⁺, and Ca²⁺ and the halogenated closo-borate salt comprises a second cation selected from the group consisting of Li⁺, Na⁺, Mg²⁺, and Ca²⁺.

6. The electrolyte according to claim 5, wherein the first cation is Li⁺ the second cation Li⁺.

7. The electrolyte according to claim 5, wherein the first cation is Nat the second cation Na⁺.

8. The electrolyte according to claim 1, wherein:
the halogen-free closo-borate salt comprises:
a Li⁺ cation and a closo-borate anion having a structure selected from the group consisting of:
[B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, and [C₂B_{(y-3)}H_{(y-t-1)}Rₜ]²⁻, and wherein:
y is an integer within a range of 6 to 12;
(z) is an integer within a range of 0 to y;
(t) is an integer within a range of 0 to (y-1); and
R is a linear, branched-chain, or cyclic C1-C18 alkyl or fluoroalkyl group; and
the halogenated closo-borate salt comprises:
a Li⁺ and a halogenated closo-borate anion having the structure selected from the group consisting of:
[B_{y}H_{(y-z-i)}R_{z}Xᵢ]²⁻, [CB_{(y-1)}H_{(y-z-i)}R_{z}Xᵢ]⁻,
[C₂B_{(y-2)}H_{(y-t-j-1)}RₜXⱼ]⁻, [C₂B_{(y-3)}H_{(y-t-j)}RₜXⱼ]⁻, and
[C₂B_{(y-3)}H_{(y-t-j-1)}RₜXⱼ]²⁻, and wherein:
y is an integer within a range of 6 to 12;
(z+i) is an integer within a range of 0 to y;
(t+j) is an integer within a range of 0 to (y-1);
X is F, Cl, Br, I, halogenated alkyl group including CF₃, or a combination thereof; and
R is a linear, branched-chain, or cyclic C1-C18 alkyl or fluoroalkyl group.

9. The electrolyte according to claim 8, wherein a cationic conductivity of the composite salt mixture at 30° C. is more than one order of magnitude greater than a cationic conductivity of the halogen-free closo-borate salt at 30° C., the cationic conductivity at 30° C. is at least one order of magnitude greater than a cationic conductivity of the halogenated closo-borate salt at 30° C., and the composite salt mixture has an activation energy less than 0.58 eV at 30° C.

10. The electrolyte according to claim 1 further comprising an organic plastic crystal, wherein the composite salt mixture is disposed within the organic plastic crystal.

11. The electrolyte according to claim 10, wherein the organic plastic crystal comprises a succinonitrile-glutaronitrile mixture.

12. The electrolyte according to claim 11, wherein the composite salt mixture comprises between 90 wt. % and 30 wt. % of the electrolyte and the organic plastic crystal comprises from about 10 wt. % to about 70 wt. % of the electrolyte.

13. The electrolyte according to claim 12 further comprising between about 0.01 mole fraction and about 0.9 mole fraction of at least one cation conductivity enhancing anion.

14. The electrolyte according to claim 13, wherein the at least one cation conductivity enhancing anion is selected from the group consisting of F⁻, Cl⁻, Br⁻, I⁻, RₓBF₄₋ₓ⁻, R_{y}PF_{6-y}⁻, SbF₆⁻, ClO₄⁻, SO₄⁻², N(SO₂F)₂⁻, N(SO₂(CF₂)ₙCF₃)₂⁻, [NSO₂(CF₂)ₙ₊₁SO₂]⁻, CF₃(CF₂)ₙSO₃⁻, and combinations thereof, where: n is 0 to 5; x is 0 to 4; y is 0 to 6; and R is a linear, branched, or cyclic alkyl group that can be partially fluorinated, or fully fluorinated.

15. The electrolyte according to claim 1, wherein the composite salt mixture is in a fully liquid molten state, partially liquid molten state, or a solid state at room temperature.

16. A secondary battery comprising the electrolyte according to claim 1.

17. An electrolyte comprising:
a composite salt mixture comprising between 0.975 and 0.05 mole fraction of a halogen-free closo-borate salt, between 0.025 and 0.95 mole fraction of a halogenated closo-borate salt, and an activation energy less than 0.65 EV for temperatures above 30° C.

18. A method comprising:
mixing a halogen-free closo-borate salt and a halogenated closo-borate salt and forming a solid state electrolyte comprising between 0.975 and 0.05 mole fraction of the halogen-free closo-borate salt, between 0.025 and 0.95 mole fraction of the halogenated closo-borate salt, and an activation energy less than 0.65 EV for temperatures equal to and above 30° C.

19. The method according to claim 18 further comprising heat treating the solid state electrolyte.

20. The method according to claim 18, wherein the mixing comprises at least one of:
mechanochemical synthetic ball milling a predefined amount of the halogen-free closo-borate salt with a predefined amount of the halogenated closo-borate salt; and
dissolving the halogen-free closo-borate salt and a halogenated closo-borate salt in a solvent, removing the solvent in a solvent removal step, and mechanically mixing the halogen-free closo-borate salt and the halogenated closo-borate salt in a ball milling homogenization step.
